(19) United States
(12) Patent Application Publication
(10) Pub. No.: US 2012/0069706 A1
(43) Pub. Date: Mar. 22, 2012

(54) Land Seismic Cable and Method

(76) Inventors: Nicolas Goujon, Oslo (NO); Emmanuel Coste, Oslo (NO); Qinglin Liu, Oslo (NO); Kevin O'Connell, Asker (NO); Jostein Fonneland, Singapore (SG); Kazuya Yoshida, Sendai (JP); Hitoshi Tashiro, Cambridge, MA (US)

(21) Appl. No.: 12/886,319

(22) Filed: Sep. 20, 2010

(51) Int. Cl. G01V 1/18; F16L 1/028

(52) U.S. Cl. 367/37; 405/174; 367/188

(57) ABSTRACT

A seismic cable for use in land applications is described. The cable includes seismic sensors for measuring seismic signals reflected from subterranean or subsea formations. The cable may be deployed in trenches dug in the survey region to provide adequate sensor coupling to ground. Sensor units may be inline with the cable and may further be disposed in slim casings, thus facilitating handling and deployment.

### BACKGROUND

This disclosure generally relates to land seismic cables for use in acquiring seismic data.

Seismic surveying is used for identifying subterranean elements, such as hydrocarbon reservoirs, freshwater aquifers, gas injection zones, and so forth. In seismic surveying, seismic sources are placed at various locations on a land surface or sea floor, with the seismic sources activated to generate seismic waves directed into a subterranean structure.

The seismic waves generated by a seismic source travel into the subterranean structure, with a portion of the seismic waves reflected back to the surface for receipt by seismic sensors (e.g., geophones, accelerometers, etc.). These seismic sensors produce signals that represent detected seismic waves. Signals from the seismic sensors are processed to yield information about the content and characteristic of the subterranean structure.

A typical land-based seismic survey arrangement includes deploying an array of seismic sensors on the ground with the seismic sensors provided in an approximate grid formation. Such surveys require that each seismic sensor be buried to achieve the desired coupling to the surface. For this reason, land-based seismic surveys can be labor intensive, often requiring dozens of crew members to manually deploy seismic sensors throughout the survey area. Accordingly, systems and methods are needed which can streamline the deployment of land-based survey equipment, while also generating the desired seismic data.

### SUMMARY

A seismic cable for use in land applications is described. The cable may include various types of seismic sensors (e.g., geophones, MEMS-based, optical and/or pressure sensors) as well as data processing functionality to process the acquired seismic data. The cable may further include a filler material, such as liquid or gel, or it may be of a solid construction.

In some embodiments, the seismic cable includes integrated MEMS devices for recording seismic data. The MEMS devices are provided in a smaller package relative to other sensor devices and thus enable automated deployment.

Related systems and methods for deploying and using the seismic cable are also described. For example, a vehicle for deploying the seismic cable may carve a trench in the earth surface to be surveyed prior to automatically deploying the cable into the trench. Additional tools for improving coupling of the cable to the earth are also described.

Additional systems and methods are described for determining orientation of sensor units deployed in a survey region as well as ensuring quality control of positioning such sensor units.

Advantages and other features of the present disclosure will become apparent from the following drawing, description and claims.

### BRIEF DESCRIPTION OF THE DRAWINGS

FIG. 1 is a schematic illustration of a deployed seismic cable according to one embodiment of the present disclosure;

FIG. 2 is a cut-away view of a seismic cable according to one embodiment of the present disclosure;

FIG. 3 is a cut-away view of another seismic cable according to one embodiment of the present disclosure;

FIG. 4 is a block diagram illustrating exemplary components of a sensor housing disposed in the seismic cable of FIGS. 1-3;

FIG. 5a is a schematic illustration of another embodiment of a seismic cable according to the present disclosure;

FIG. 5b illustrates the cable of FIG. 5a with an added jacket extruded over the cable;

FIGS. 6a-6c illustrate alternative sensor housings for use with the cable of FIG. 5;

FIG. 7 illustrates a sensor housing according to another embodiment of the present disclosure;

FIG. 8 illustrates a sensor housing according to yet another embodiment of the present disclosure;

FIG. 9 illustrates a snap-on component for improving coupling between the cable and the terrain of interest according to another embodiment of the present disclosure;

FIG. 10 illustrates a schematic view of a seismic cable according to another embodiment of the present disclosure;

FIG. 11a illustrates a schematic view of a deployment arrangement for deploying a seismic cable according to one embodiment of the present disclosure;

FIG. 11b illustrates a schematic view of an alternative deployment arrangement for deploying seismic cable according to one embodiment of the present disclosure;

FIG. 12 illustrates a schematic view of an alternative trenching method according to one embodiment of the present disclosure; and

FIG. 13 illustrates is a schematic diagram of a data processing system for carrying out processing techniques according to the present disclosure.

### DETAILED DESCRIPTION

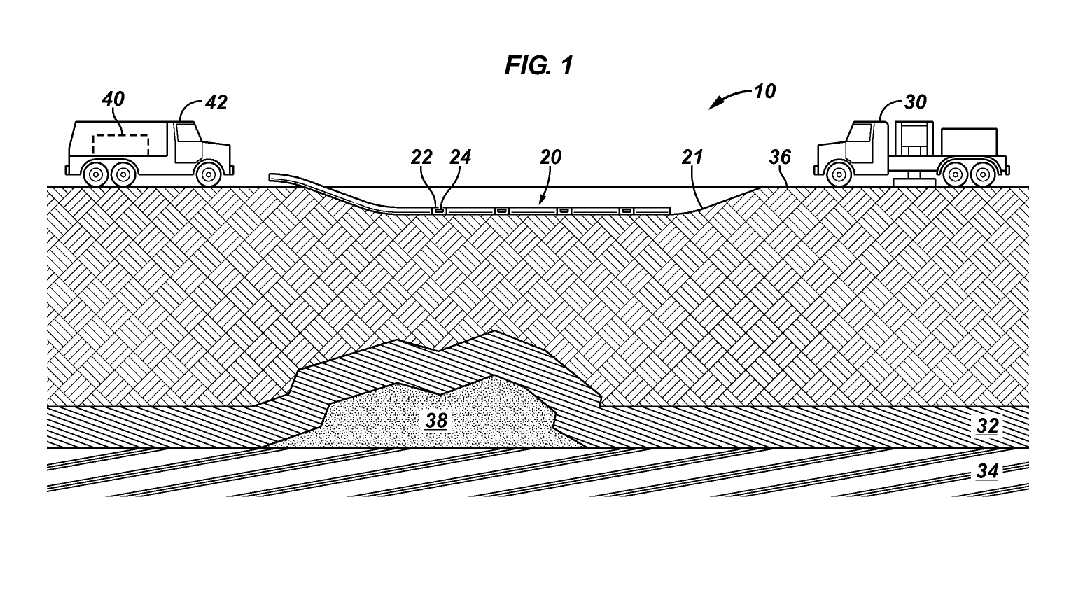

FIG. 1 depicts an embodiment of a land seismic data acquisition system 10 in accordance with some embodiments of the disclosure. For the purposes of this disclosure, “land” applications include seismic data acquisition in transition zone areas, such as marshes, wetlands and other shallow water applications. In the system 10, a seismic cable 20 for use in acquiring seismic data in land applications lies in a trench 21 formed in a terrain of interest. While only one section of the seismic cable 20 is shown in FIG. 1, it is to be appreciated that the seismic cable 20 may be formed of a plurality of sections coupled to one another. In some embodiments, the seismic cable 20 may extend several thousand meters long and may contain various support cables (not shown), as well as wiring and/or circuitry (not shown) that may be used to support communication along the cable 20. The cable 20 generally includes sensor units 22, which house seismic sensors 24 that record seismic signals.

In accordance with embodiments of the disclosure, the seismic sensors 24 may be pressure sensors only, particle motion sensors only, or may be multi-component seismic sensors. For the case of multi-component seismic sensors, the sensors are capable of detecting a pressure wavefield and at least one component of a particle motion that is associated with acoustic signals that are proximate to the multi-component seismic sensor. Examples of particle motions include one or more components of a particle displacement, one or more components (inline (x), crossline (y) and vertical (z) components) of a particle velocity and one or more components of a particle acceleration.

Depending on the particular embodiment of the disclosure, the multi-component seismic sensors may include one or more geophones, hydrophones, particle displacement sensors, optical sensors, particle velocity sensors, accelerometers, pressure gradient sensors, or combinations thereof

For example, in accordance with some embodiments of the disclosure, a particular multi-component seismic sensor may include three orthogonally-aligned accelerometers (e.g., a three-component micro electro-mechanical system (MEMS) accelerometer) to measure three corresponding orthogonal components of particle velocity and/or acceleration near the seismic sensor. In such embodiments, the MEMS-based sensor may be a capacitive MEMS-based sensor of the type described in co-pending U.S. patent application Ser. No. 12/268,064, which is incorporated herein by reference. Of course, other MEMS-based sensors may be used according to the present disclosure. In some embodiments, a hydrophone for measuring pressure may also be used with the three-component MEMS described herein.

It is noted that the multi-component seismic sensor may be implemented as a single device or may be implemented as a plurality of devices, depending on the particular embodiment of the disclosure. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, at a particular point, seismic data indicative of the pressure data with respect to the inline direction.

It is noted that measurements acquired by a particle motion sensor are susceptible to noise. For purposes of substantially canceling, or attenuating, this noise, the sensor units 22 may include a rotation sensor. More specifically, the rotation sensor measures a torque noise, which serves as a basis for estimating a noise (such as a torque noise, for example) that is present in the measurement that is acquired by the particle motion sensor. Given the estimate, the noise may be significantly removed, or attenuated.

The system 10 generally includes a seismic source, such as a vibrator truck 30, which is used to impart seismic vibrations into the earth's surface. Of course, other methods for generating seismic vibrations may be used, such as dynamite, air guns, etc. Acoustic signals, often referred to as “shots,” are produced by the seismic source 30 and are directed down through strata 32 and 34 beneath the earth's surface 36. The acoustic signals are reflected from the various subterranean geological formations, such as an exemplary formation 38 that is depicted in FIG. 1. The incident acoustic signals that are generated by the source 30 produce corresponding reflected acoustic signals, or pressure waves, which are sensed by the seismic sensors 24 disposed in the cable 20.

The seismic sensors 24 generate signals (digital signals, for example), called “traces,” which indicate the acquired measurements of the pressure wavefield and particle motion (if the sensors are particle motion sensors). The traces are recorded and may be at least partially processed by a signal processing unit 40 deployed in or near the survey region, in accordance with some embodiments of the disclosure. The signal processing unit 40 may, for example, be disposed in a recording truck 42 movably positioned at various locations of the survey region. A particular multi-component seismic sensor may provide a trace, which corresponds to a measure of a pressure wavefield by its hydrophone; and the sensor may provide one or more traces that correspond to one or more components of particle motion, which are measured by its accelerometers, for example.

The goal of the seismic acquisition is to build up an image of a survey area for purposes of identifying subterranean geological formations, such as the exemplary geological formation 38. Subsequent analysis of the representation may reveal probable locations of hydrocarbon deposits in subterranean geological formations. Depending on the particular embodiment of the disclosure, portions of the analysis of the representation may be performed proximate the survey region, such as by the signal processing unit 40.

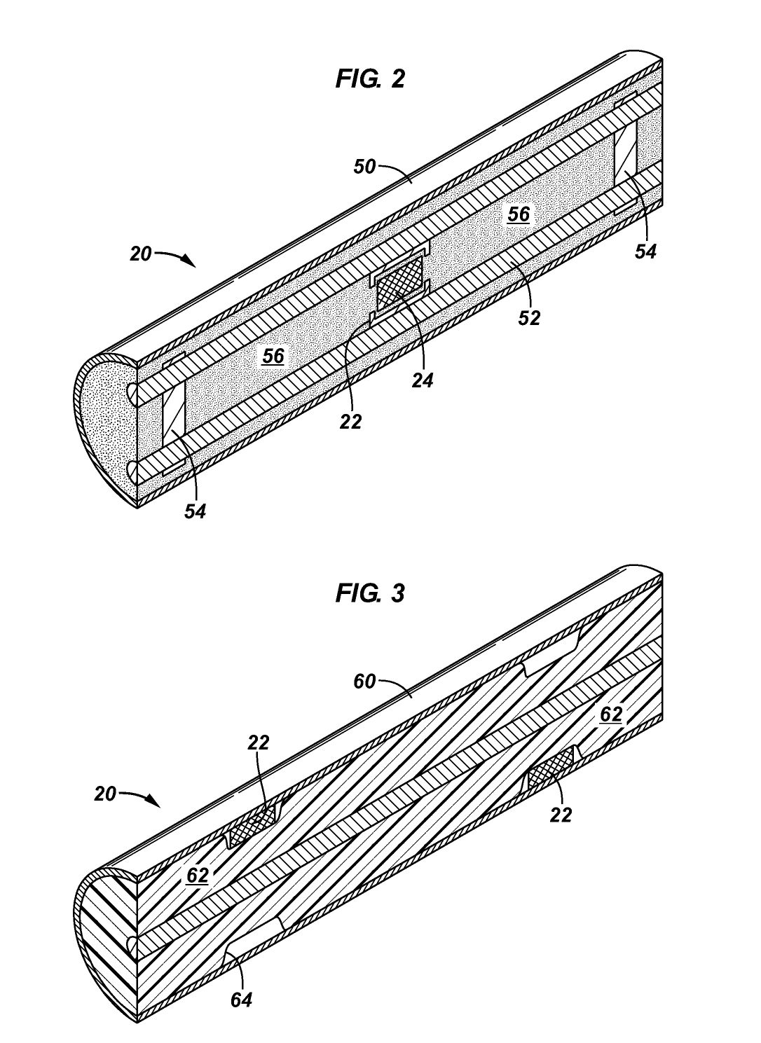

The seismic cable 20 according to the present disclosure may be constructed as a liquid or gel-filled cable, or alternatively, as a solid cable. Referring to FIG. 2, the main mechanical parts of an embodiment of the liquid or gel-filled seismic cable 20 include skin 50 (the outer covering); one or more stress members 52; the sensor units 22 with seismic sensors 24 discussed above; spacers 54 to support the skin and protect the seismic sensors; and a filler material 56, which may be liquid, gel or a solid. The skin 50 may be formed of plastic or another material of sufficient elasticity such that the cable 20 can be easily rolled and deployed as will be further described below. Moreover, the skin 50 should be sufficiently strong to withstand weather (e.g., ultraviolet radiation), and forces such as tensile stresses incurred during deployment and water ingress and erosion effects.

Referring to the filler material 56, in liquid embodiments, the cable 20 may be filled with a hydrocarbon liquid such as kerosene, while in gel embodiments, the cable may be filled with a gel formed of a combination of hydrocarbon liquid and a polymer. The filler material 56 may provide better coupling of the sensors, particularly for embodiments where pressure sensors are employed in the cable 20. Referring to FIG. 3, the seismic cable 20 may alternatively be formed as a solid cable to include a skin 60 surrounding a polymer body 62 having pockets 64 defined therein for receiving the sensor units 22.

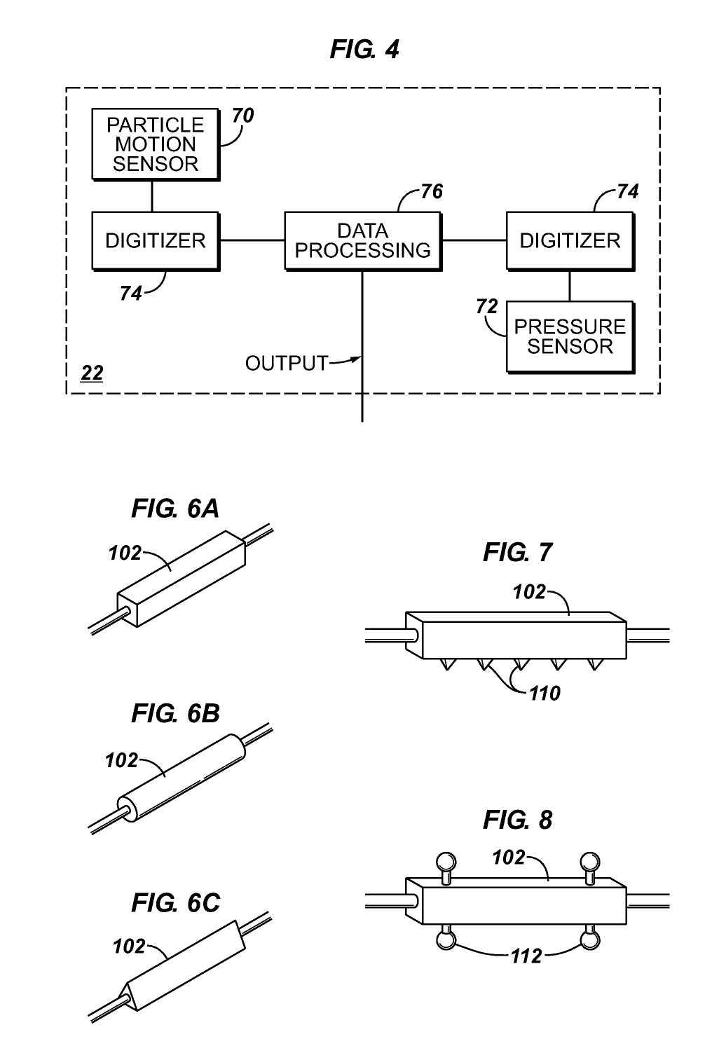

In one embodiment, and with reference to FIG. 4, the sensor unit 22 includes a particle motion sensor 70, which may be a 3-component geophone accelerometer (GAC), a 3-component MEMS-based sensor, or an optical sensor, and a pressure sensor 72, which may be a hydrophone. Additional electronics may be provided in the sensor unit, such as digitizers 74, for digitizing the seismic signal before passing it to a central processing unit (CPU) 76. In some embodiments, the sensor unit 22 outputs an analog signal, which is then digitized elsewhere, such as in the recording truck 42. The output of the sensor unit 22 may be one component (e.g., vertical component after data processing or pressure wave), two component (e.g., vertical component after data processing and pressure wave), three component (e.g., two particle motion measurements and pressure wave or three particle motion measurements), or four component (three component particle motion measurements and pressure wave). The sensor units 22 may be densely distributed along the cable 20 to achieve desired spatial sampling. For example, the sensor units 22 may be distributed along the cable 20 at intervals of 1 m, 5 m, 10 m depending on the desired spatial sampling. In other embodiments, the spacing may be at intervals of 6.25 m, 12.5 m, 25 m, or 50 m. Other spacing intervals are contemplated as different sensor types have different sensor spacings.

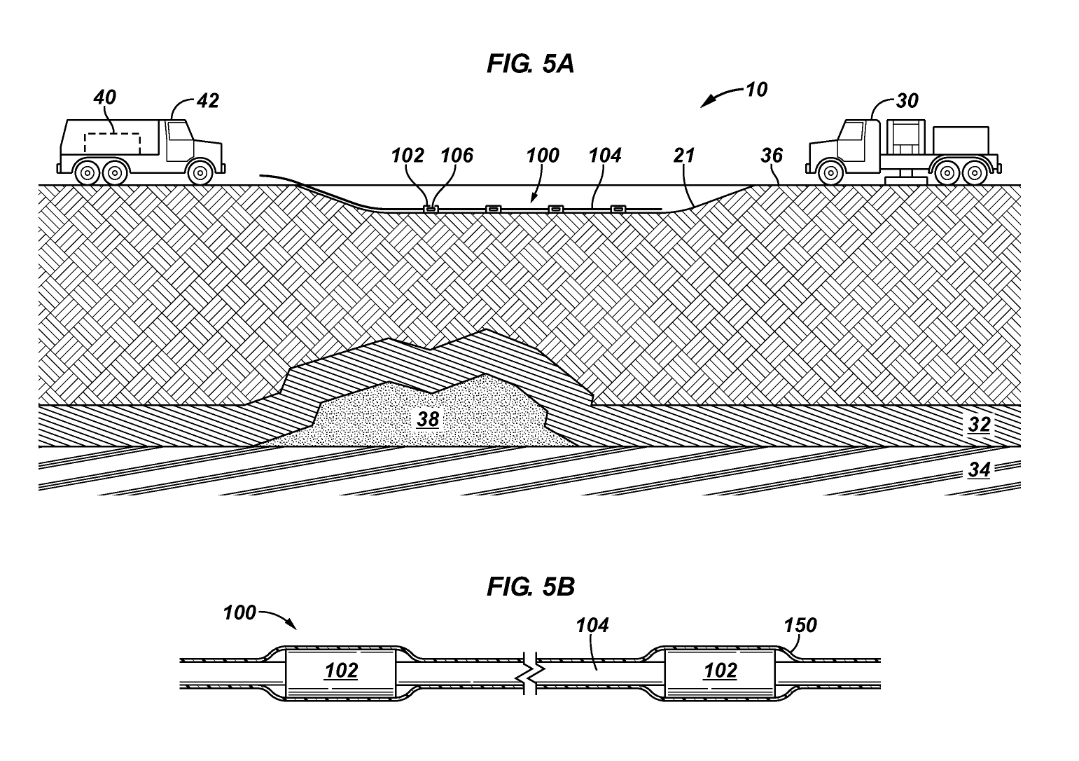

Referring to FIG. 5a, an alternative land cable 100 includes a plurality of sensor units 102 connected via a wiring bundle 104, which may include various electrical and/or optical wiring for connecting the sensors disposed along the cable. The land cable 100 may be similar in some respect to cable 20 in that the sensor units 22, 102 may have common features (e.g., sensors) and common principles of electrical wiring and communication may be applied to both cables. Several such types of sensor units 22, 102 are contemplated to fall within the scope of the present disclosure in addition to the embodiments described with respect to FIGS. 1-4. For example, the sensor units 22, 102 may include a digitization board with associated sensors bundled in one package. In other embodiments, the units 22, 102 contain only sensors with electronics modules being connected along the cable 20 at regular intervals. In further embodiments, the cables 20, 100 may take the form of an all optical solution, thus including geophones and fiber optic cabling. In optical embodiments, a laser emitter/receiver may be provided with the deployment vehicle (to be described), or alternatively, the laser emitter/receiver may be connected to a main node that is periodically deployed in the field.

In one particular embodiment of FIG. 5a, the sensor units 102 include a three-component MEMS-based accelerometer, which permits the sensor units to be reduced in size relative to other seismic sensor units known in the art. With the reduction in size, a smaller cable 100 may be used, thus leading to simplified handling and deployment. Indeed, in some embodiments, the sensor units 102 may have a larger cross-sectional area relative to the wiring bundle 104. In addition, the sensor units 102 are integrated with the cable 100 such that they are substantially in-line and fixed in orientation with the cable, thus further simplifying deployment as will be described. In some embodiments, the sensor units 102 may not be fixed in orientation and rather utilize compass or magnetometer technology to measure heading.

Referring to FIG. 5b, the land cable 100 may be modified to include a jacket 150 extruded over the sensor units 102 and wiring bundle 104. The jacket 150 may be formed of a polyurethane elastomer to thus provide increased protection of the sensor units 102 and associated wiring 104. As with the embodiment of FIG. 5a, the cable 100 may have a larger diameter associated with the sensor units 102 with a reduced diameter associated with the wiring bundle 104.

The sensor units of FIGS. 5a and 5b may be provided in a smaller package, or casing, relative to other sensor units currently known in the art. The “slim” casings 102 of FIGS. 5a and 5b thus facilitate spooling and deployment of the cable 100 as will be described. It is to be appreciated that various types (including those of different shapes) of slim casings 102 may be used to enclose the sensor 104.

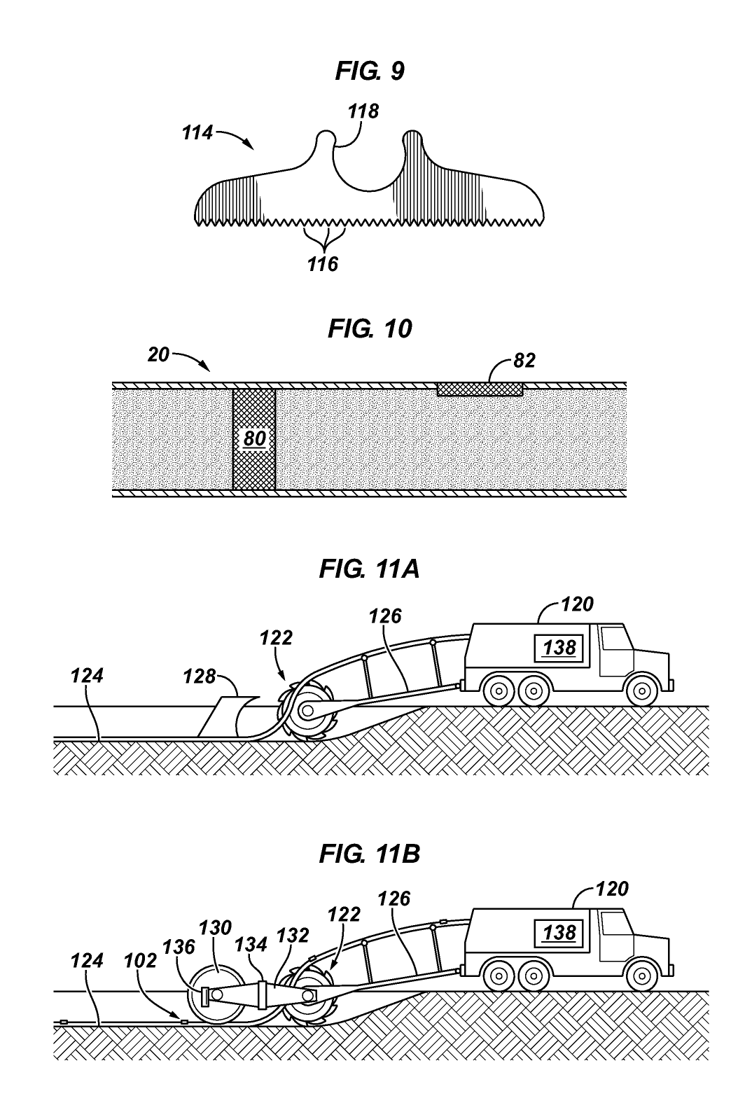

Slim casings of varying cross-sectional shape may be used according to the present disclosure. For example, rectangular (FIG. 6A), cylindrical (FIG. 6B) and triangular (FIG. 6C) types of casings 102 may be employed depending on the particular circumstances of the survey. Also, various coupling mechanisms are contemplated for use with the slim casings 102 to provide increased coupling between the casing and the terrain of interest. For example, with reference to FIG. 7, cleats 110 may be formed on a portion of the slim casing 102 to thus increase coupling to the terrain. FIG. 8 illustrates an alternative coupling mechanism in the form of anchors 112 disposed adjacent to terminal ends of the casing 102. Still further, with respect to FIG. 9, a snap-on coupling mechanism 114 may be provided such that the coupling mechanism can be easily attached to the cable 100 to thus provide increased coupling with the terrain of interest. The coupling mechanism 114 has a base 116, which is adapted for contact with and coupling to the area to be surveyed. In some embodiments, the base 116 may have rough surface to provide the desired coupling. In practice, the cable 100 is disposed through the recess 118 defined in the coupling mechanism prior to deployment. Accordingly, together with the shape of the casing 102, the coupling mechanisms (e.g., 110, 112, 114) increase the likelihood of adequate sensor to ground coupling for land survey purposes.

The cables 20, 100 described herein may be formed of sections of uniform or varying size. In some embodiments, the sections are formed to be 50 m long, while in other embodiments, the sections may be 100 m, 200 m or some other unit of length. Referring to FIG. 10, power units 80 may be inserted into the cables 20, 100 in an inline or eccentric manner at various locations along the cables. In addition, solar power units 82 may be utilized to harness solar energy and thus lower the power consumption of the cables 20, 100. In some embodiments, the cables 20, 100 may take the form of nodal cables, which permits local data storage, which can be transferred from the cables at a later time. For example, the sensor units 22, 102 may include a memory device (as described further with reference to FIG. 13) for storing seismic data locally, thus rendering unnecessary transmission lines for sending acquired data back to the recording truck 42.

Deployment of the cable 20 in the survey region may be accomplished in an automated manner, thus reducing labor costs while increasing efficiency in deployment. In addition, automated deployment also permits the usage of a smaller number of connectors for the cable 20, which thus reduces cost and improves handling. In one embodiment, and with reference to FIG. 11a, a deployment vehicle 120, such as a truck, may be used to deploy the cable 20. The vehicle 120 includes a deployment tool 122, which may function to dig a trench 124 for placement of the cable 20 therein. In the embodiment of FIG. 11a, the deployment tool 122 takes the form of a wheel; however, it is to be appreciated that the deployment tool may take on other configurations, such as a plough-like device, so long as it functions to form the trench 124. The trench 124 increases coupling of the cable 20 to the ground, and thus may be formed to have a depth of approximately 5-30cm. The deployment tool 122 is operatively connected to the vehicle 120, such as via a connector line 126. The cable 20 may be stored on a reel (not shown) in the back of the vehicle 120 and spooled into the trench 124 via deployment tool 122. To accommodate spooling, the deployment tool 122 may have a groove defined there along through which the cables 20, 100 of the present disclosure pass to thus guide the cables into the trench.

In some embodiments, a covering tool 128 may be used for applying terrain to the top of the cable 20 to further couple the cable to the ground. The tool 128 may also function to apply pressure to the cable 20 to further increase coupling to the ground. In some embodiments, the covering tool 128 is coupled to the deployment tool 122, while in other embodiments the covering tool may be provided separately from the deployment vehicle 120. In embodiments where the covering tool is provided separately, it may be associated with another vehicle that follows the trajectory of the deployment vehicle to cover and compress the sensor units 102 into the terrain of interest.

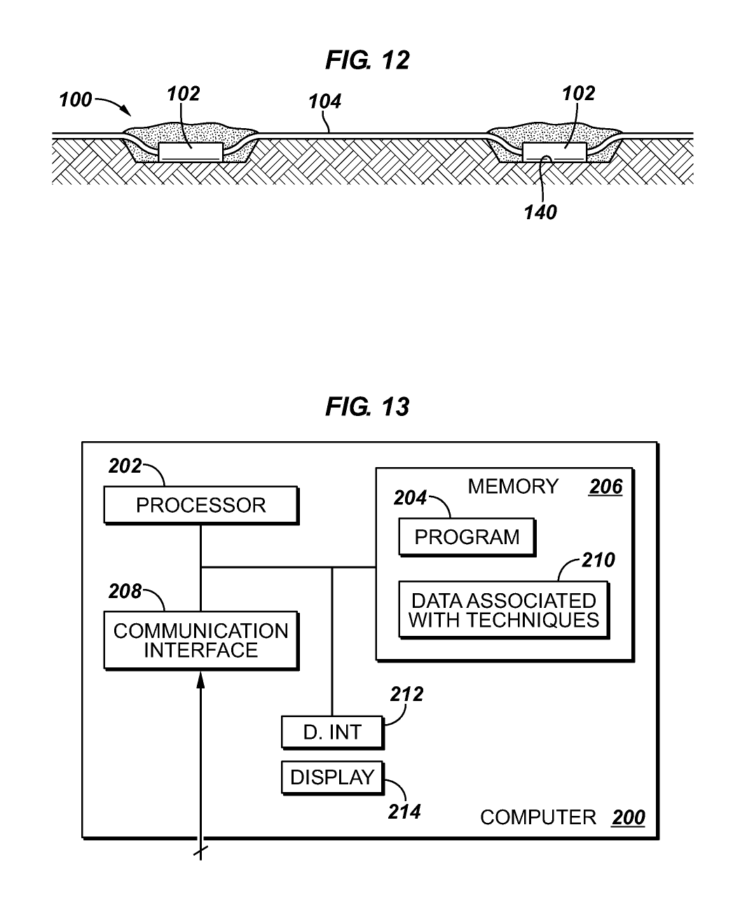

FIG. 11b depicts an alternative embodiment in which a roller device 130 is connected to the deployment tool 122 via a connector arm 132. The connector arm 132 includes a hinge 134, which permits the roller device 130 to follow the trajectory of the vehicle 120. In practice, the roller device 130 applies force to the cable 20 to improve coupling between the sensor units 102 and the earth. Although the embodiments of FIGS. 11a and 11b are exemplary implementations of certain aspects of the present disclosure, various other embodiments of performing back-fill operations (applying terrain to the sensor units such as depicted in FIG. 12) and compression operations (applying pressure to the sensor units and/or back-filled terrain to increase coupling to the terrain) are contemplated. Also, in some embodiments, the deployment tool 122 may be disposed at other positions relative to the vehicle 120. For example, the deployment tool 122 may be disposed underneath the vehicle 120 or in front of the vehicle.

Referring again to FIG. 11b, in some embodiments, the sensor units 102 may be modified to include a radio frequency (RF) device, such as a radio frequency identification (RFID) device, to send/receive data to/from a platform outside of the cable 20. In such embodiments, a communication unit 136 may be preferably disposed on the connector arm 132 and adjacent to the roller device 130 and include electronics for detecting a particular sensor unit 102 when it passes underneath the roller device 130. The communication unit 136 may then communicate with the vehicle 120 to determine the position of the sensor unit 102 via a positioning system in the vehicle (e.g., a Global Navigation Satellite System). A control unit 138, as will be further described, may be provided in the vehicle 120 to control such communications. The position of the sensor unit 102 may then be communicated back to the communication unit 136, which then sends the positioning data to the RF component of the sensor unit 102 to record its positioning coordinates. Such coordinates may be used during further processing of the acquired seismic data.

It is to be appreciated that various alternative methods for trenching may be used according to the principles of the present disclosure. For example, with reference to FIG. 1, a continuous trench may be carved into the earth's surface to accommodate the land cable 20. However, in other embodiments, such as those discussed with reference to FIG. 5, trenching operations may either be continuous or intermittent. That is, a series of trenches 140, such as those depicted schematically in FIG. 12 may be formed in the earth's surface to accommodate adequate coupling of the sensor casings, while not burying the wiring bundle 104. Accordingly, the deployment tool may be operative to intermittently engage with and disengage from the earth's surface.

It is to be appreciated that the cables 20, 100 with integrated sensors according to the present disclosure simplify orientation determination. As the sensors 24, 104 are integrated in their respective cables 20, 100, they are thus aligned with the cables 20, 100. Accordingly, sensor heading may simply be determined by measuring the heading of the deployment vehicle itself or the deployment tool positioned on the vehicle. In some embodiments, the heading of the sensor may be measured based on the track of the deployment vehicle as measured by a Global Navigation Satellite System (GNSS) (e.g., Global Positioning System (GPS) owned and operated by the U.S. Department of Defense). Also, in embodiments where three-component sensors are used, the cable can be deployed without regard to position and tilt as the vertical component signal can be reconstructed from the sample three-dimensional wavefield. Current methods require laborers associated with deployment of the survey to pre-plan the position and tilt of each sensor unit. That is, a laborer must physically identify the location of each sensor unit deployed in the survey region and then flag that location for other laborers to deploy the sensor units. As can be appreciated, this is a labor intensive process given the thousands of sensor units often associated with a single survey. The method according to the present disclosure eliminates the need for physical positioning of the sensor units, thus reducing labor costs and improving efficiency in deployment.

In some embodiments, the systems and methods of the present disclosure may be modified to permit deployment of sensor units 22, 102 according to pre-defined quality indicators, such as position, tilt, etc. The quality indicators may be defined in the control unit 138 (FIGS. 11a and 11b) provided in the deployment vehicle 120. In some embodiments, the control unit 138 may be a processor-based system that provides an interface between the navigation system of the vehicle (e.g., GNSS-type system) and the cable deployment system. One of the roles of the navigation system is to monitor the vehicle position, speed and direction and to integrate the survey plan, which includes the planned coordinates for each sensor along with pre-defined quality indicators for each sensor. In some embodiments, the control unit 138 may be a feedback control system, which will trigger sensor deployment based on the vehicle navigation information provided in real-time and the survey plan. The control unit 130 may also employ additional sensors, such as wheel and visual odometry, and laser range sensors to provide a more precise estimate of the vehicle position tracking It is to be appreciated that deployment quality data may be transmitted in real time to a remote monitoring station, such as a recording truck, field control center or base camp control center.

Referring to FIG. 13, in accordance with some embodiments of the present disclosure, a data processing system 200 may include a processor 202 that is constructed to execute at least one program 204 (stored in a memory 206) for purposes of processing data to perform one or more of the techniques that are disclosed herein (e.g., using the control unit 130 to process the data fed from the navigation system and feed data to the cable deployment system). The processor 202 may be coupled to a communication interface 208 for purposes of receiving data. In addition to storing instructions for the program 204, the memory 206 may store preliminary, intermediate and final datasets involved in the techniques (data associated with techniques 110) that are disclosed herein. The pre-defined quality indicators, for example, may be stored in such a manner. Among its other features, the data processing system 200 may include a display interface 212 and display 214 for purposes of displaying the various data that is generated as described herein.

The control unit can thus guide the deployment vehicle to deploy the sensor units 22 at optimal positions in the survey region to ensure compliance with survey requirements. Deploying the sensor units 22 according to pre-defined quality indicators will also improve the quality of the survey. In particular, it will reduce errors in the sensor unit recordings, thus minimizing the need to compensate for errors in position, tilt, etc. As can be appreciated, such errors are common with conventional deployment techniques in which laborers physically deploy the sensor units 22. In some embodiments, the sensor units 22 may be tested after deployment to ensure compliance with the quality indicators. If it is determined that the sensor units 22 are not appropriately positioned, then correction can be made.

While the present disclosure has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present disclosure.

What is claimed is:

1. A method for land-based seismic surveying, comprising:
providing a seismic cable having a plurality of sensor units integrated into the cable, at least some of the sensor units having multi-component sensors disposed therein;
forming a trench in a terrain of interest;
deploying the sensor units into the trench; and
using the sensor units to record seismic data.

2. A method according to claim 1, wherein providing a seismic cable comprises providing a liquid-filled cable.

3. A method according to claim 1, wherein providing a seismic cable comprises providing a gel-filled cable.

4. A method according to claim 1, wherein providing a seismic cable comprises providing a solid cable.

5. A method according to claim 1, wherein providing a seismic cable comprises providing a cable having a three-component particle motion sensor.

6. A method according to claim 1, wherein providing a seismic cable comprises providing a cable having a three-component MEMS accelerometer.

7. A method according to claim 1, wherein providing a seismic cable comprises providing a cable having a particle motion sensor and a pressure sensor.

8. A method according to claim 1, wherein forming a trench comprises providing a deployment vehicle, the deployment vehicle having a deployment tool operatively connected thereto.

9. A method according to claim 8, wherein forming a trench comprises engaging the deployment tool with the terrain of interest in a continuous manner.

10. A method according to claim 8, wherein forming a trench comprises engaging the deployment tool with the terrain of interest in an intermittent manner.

11. A method according to claim 8, wherein deploying the sensor units comprises spooling the cable onto terrain and deploying the sensor units into the trench via the deployment tool.

12. A method according to claim 8, further comprising providing a covering tool, the covering tool being operatively connected to the deployment vehicle.

13. A method according to claim 12, further comprising using the covering tool to impart pressure to the sensor units to increase coupling of the cable to the terrain of interest.

14. A method according to claim 12, further comprising using the covering tool to apply terrain to the sensor units to increase coupling of the cable to the terrain of interest.

15. A seismic cable for land-based seismic surveying, comprising:
a plurality of sensor units integrated into the cable such that the sensor units are in-line with the cable; and
a multi-component sensor disposed in the sensor unit.

16. A seismic cable according to claim 15, wherein the multi-component sensor comprises a three-component particle motion sensor.

17. A seismic cable according to claim 16, wherein the three-component particle motion sensor is a MEMS-based accelerometer.

18. A seismic cable according to claim 15, wherein the cable extends into one end of the sensor units and extends out of the other end of the sensor units.

19. A seismic cable according to claim 15, wherein the sensor units are packaged in sensor casings and the shape of at least one of the sensor casings is a rectangle, a square, a triangle, or a circle in cross-section.

20. A seismic cable according to claim 15, wherein the sensor units are packaged in sensor casings and at least one of the sensor casings includes a coupling mechanism extending therefrom, the coupling mechanism increasing coupling of the sensor casing to a terrain of interest.

21. A seismic cable according to claim 20, wherein the coupling mechanism includes at least one cleat extending from the casing, the cleat being useful for engaging the terrain of interest.

22. A seismic cable according to claim 20, wherein the coupling mechanism includes at least one anchor extending from the casing, the anchor being useful for engaging the terrain of interest.

23. A seismic cable according to claim 20, wherein the coupling mechanism comprises a snap-on device having a base surface for engaging the terrain of interest.

24. A seismic cable according to claim 15, wherein the sensor units are fixed in orientation with the cable.

25. A seismic cable according to claim 15, wherein the sensor units have a larger cross-sectional area relative to other portions of the cable.

26. A seismic cable according to claim 15, wherein the cable is sized and shaped to allow for spooling on a reel.
